(19) United States
(12) Patent Application Publication
(10) Pub. No.: US 2012/0163356 A1
(43) Pub. Date: Jun. 28, 2012

(54) IMPLICIT BEAMFORMING USING PARTIAL CHANNEL STATE INFORMATION

(75) Inventors: Nir Shapira, Ra'anana (IL); Amir Helfan, Tel Aviv (IL)

(73) Assignee: CELENO COMMUNICATIONS (ISRAEL) LTD., Ra'anana (IL)

(21) Appl. No.: 13/245,896

(22) Filed: Sep. 27, 2011

Related U.S. Application Data
(60) Provisional application No. 61/427,413, filed on Dec. 27, 2010.

(51) Int. Cl. H04W 84/12

(52) U.S. Cl. 370/338

(57) ABSTRACT

A method for communication includes, in a first communication station, receiving from a second communication station via multiple antennas an input signal having a spectrum that occupies an initial set of spectral bins. An extended set of the spectral bins, which includes the initial set and one or more additional spectral bins, is defined. Based on the received input signal, respective beam steering matrices are computed for the spectral bins in the extended set, including the additional spectral bins. The output signal is generated over the extended set of the spectral bins, including the additional spectral bins, using the respective beam steering matrices. The output signal is transmitted from the first communication station via the multiple antennas.

### CROSS-REFERENCE TO RELATED APPLICATIONS

This application claims the benefit of U.S. Provisional Patent Application 61/427,413, filed Dec. 27, 2010, whose disclosure is incorporated herein by reference.

### FIELD OF THE INVENTION

The present invention relates generally to communication systems, and particularly to methods and systems for implicit beamforming.

### BACKGROUND OF THE INVENTION

Some wireless communication systems use beamforming—a spatial filtering technique in which a transmitter uses multiple transmit antennas to steer a directional transmission beam toward a receiver. Beamforming techniques for use in Wireless Local Area Networks (LANs) are specified, for example, in IEEE Standard 802.11n, entitled “IEEE Standard for Information Technology—Telecommunications and Information Exchange between Systems—Local and Metropolitan Area Networks—Specific Requirements; Part 11: Wireless LAN Medium Access Control (MAC) and Physical Layer (PHY) Specifications; Amendment 5: Enhancements for Higher Throughput,” October, 2009, which is incorporated herein by reference.

The IEEE 802.11n standard defines two beamforming modes—explicit feedback beamforming and implicit feedback beamforming. In explicit feedback beamforming, the transmitter uses feedback from the receiver regarding the Multiple-Input Multiple-Output (MIMO) channel in order to set appropriate beam steering matrices. In implicit feedback beamforming, the transmitter does not rely on explicit channel state feedback from the receiver under the assumption that the MIMO channel is reciprocal. Beamforming in general is defined in section 20.3.12, implicit beamforming is defined in section 30.3.12.1, and explicit beamforming is defined in section 20.3.13.2.

The description above is presented as a general overview of related art in this field and should not be construed as an admission that any of the information it contains constitutes prior art against the present patent application.

### SUMMARY OF THE INVENTION

An embodiment of the present invention that is described herein provides a method for communication in a first communication station. The method includes receiving from a second communication station via multiple antennas an input signal having a spectrum that occupies an initial set of spectral bins. An extended set of the spectral bins, which includes the initial set and one or more additional spectral bins, is defined. Based on the received input signal, respective beam steering matrices are computed for the spectral bins in the extended set, including the additional spectral bins. The output signal is generated over the extended set of the spectral bins, including the additional spectral bins, using the respective beam steering matrices. The output signal is transmitted from the first communication station via the multiple antennas.

In some embodiments, the input signal is received over a communication channel, and computing the beam steering matrices includes: based on the input signal, computing respective estimates of the communication channel for the spectral bins in the initial set; based on the estimates computed for the initial set, generating respective additional estimates of the communication channel for the additional spectral bins; and computing the beam steering matrices for the extended set based on the estimates and the additional estimates.

In an embodiment, generating the additional estimates of the communication channel includes interpolating or extrapolating or duplicating one or more of the estimates computed for the initial set. In a disclosed embodiment, the method includes applying a smoothing operation to the estimates of the communication channel for the spectral bins in the initial set before generating the additional estimates, or jointly to the estimates and the additional estimates after generating the additional estimates.

In another embodiment, the input signal is received over a communication channel, and computing the beam steering matrices includes: based on the input signal, computing respective estimates of the communication channel for the spectral bins in the initial set; computing the beam steering matrices for the spectral bins in the initial set based on the estimates; and based on the beam steering matrices computed for the initial set, generating respective additional beam steering matrices for the additional spectral bins.

In yet another embodiment, generating the additional beam steering matrices includes interpolating or extrapolating or duplicating one or more of the beam steering matrices computed for the initial set. In still another embodiment, the method includes soliciting the second communication station to transmit the input signal by sending a message from the first communication station to the second communication station.

In an embodiment, generating the output signal includes scaling a power of the output signal to compensate for a ratio between a first number of the spectral bins in the initial set and a second number of the spectral bins in the extended set. The method may include computing a Signal to Noise Ratio (SNR) metric for the beam steering matrices of the extended set based on the SNR metric of the steering matrices of the initial set. Computing the SNR metric for the extended set may include scaling the SNR metric of the initial set by a ratio between a first number of the spectral bins in the initial set and a second number of the spectral bins in the extended set.

In some embodiments, the initial set of the spectral bins corresponds to a first transmission mode, and the extended set of the spectral bins corresponds to a second transmission mode, different from the first transmission mode. In an example embodiment, the input and output signals conform to an IEEE 802.11n standard, the first transmission mode includes a non-HT duplicate mode and the second transmission mode includes a HT-40 mode.

There is additionally provided, in accordance with an embodiment of the present invention, a communication apparatus including reception circuitry, processing circuitry and transmission circuitry. the reception circuitry is configured to receive from a remote communication station via multiple antennas an input signal having a spectrum that occupies an initial set of spectral bins. The processing circuitry is configured to define an extended set of the spectral bins including the initial set and one or more additional spectral bins, and to compute, based on the received input signal, for the spectral bins in the extended set including the additional spectral bins, respective beam steering matrices. The transmission circuitry is configured to generate and transmit the output signal via the multiple antennas over the extended set of the spectral bins, including the additional spectral bins, using the respective beam steering matrices.

The present invention will be more fully understood from the following detailed description of the embodiments thereof, taken together with the drawings in which:

### BRIEF DESCRIPTION OF THE DRAWINGS

FIG. 1 is a block diagram that schematically illustrates an Access Point (AP) in a Wireless Local Area Network (WLAN), in accordance with an embodiment of the present invention;

FIG. 2 is a diagram showing spectra of signals used in an implicit feedback beamforming process, in accordance with an embodiment of the present invention; and

FIG. 3 is a flow chart that schematically illustrates a method for implicit feedback beamforming, in accordance with an embodiment of the present invention.

### DETAILED DESCRIPTION OF EMBODIMENTS

### Overview

In a typical beamforming process, a transmitter (referred to as the “beamformer”) precodes a signal using one or more beam steering matrices, and transmits the precoded signal via multiple antennas. The precoding operation applies weights to the multiple antennas, and thus causes the transmitted signal to be directed (“steered”) toward the intended receiver (referred to as the “beamformee”).

The beam steering matrices typically depend on the response of the Multiple-Input Multiple-Output (MIMO) communication channel from the beamformer to the beamformee. When the transmitted signal occupies multiple spectral bins, such as in an Orthogonal Frequency Division Multiplexing (OFDM) signal, the transmitter typically computes a respective beam steering matrix for each spectral bin depending on the channel response at the bin frequency.

When performing implicit feedback beamforming, the beamformer does not rely on explicit feedback from the beamformee regarding the communication channel in order to compute the beam steering matrices. Instead, the beamformer computes the beam steering matrices by analyzing signals received from the beamformee, assuming that the channel is reciprocal, i.e., that the channel from the beamformee to the beamformer is indicative of the channel from the beamformer to the beamformee. Implicit feedback beamforming is useful, for example, for communicating with beamformees that do not support explicit feedback beamforming, or do not support beamforming altogether.

In some practical scenarios, however, the signal received from the beamformee (based on which the beamformer is to compute the beam steering matrices) does not cover the entire spectrum of the signal to be transmitted by the beamformer. In other words, the signal to be transmitted by the beamformer occupies at least one spectral bin for which no signal is received from the beamformee. In the absence of a received signal, a conventional beamformer is unable to estimate the channel and compute beam steering matrices for the missing spectral bins.

Embodiments of the present invention that are described hereinbelow provide improved methods and systems for implicit feedback beamforming. In the disclosed embodiments, the beamformer receives from the beamformee an input signal that occupies a certain initial set of spectral bins. The beamformer defines an extended set of spectral bins, over which an output signal is to be transmitted to the beamformee. The extended set comprises the initial set, plus one or more additional spectral bins that do not appear in the initial set.

Based on the received input signal, the beamformer computes respective beam steering matrices for the spectral bins in the extended set, including the additional spectral bins. The beamformer then generates the output signal over the extended set of spectral bins using the respective beam steering matrices, and transmits the output signal toward the beamformee.

The beamformer may compute the beam steering matrices for the additional (“missing”) spectral bins in various ways. In one embodiment, the beamformer estimates the channel response for the initial set of spectral bins based on the received input signal, and uses these estimates to estimate the channel response for the additional spectral bins. Having estimated the channel for the entire extended set of spectral bins, the beamformer computes beam steering matrices for the extended set, including the additional spectral bins.

In an alternative embodiment, the beamformer estimates the channel and computes beam steering matrices for the initial set of spectral bins based on the received input signal. Then, the beamformer uses the beam steering matrices of the initial set to generate beam steering matrices for the additional spectral bins.

Having produced beam steering matrices for the entire extended set of spectral bins, the beamformer precodes the output signal using the matrices and transmits the output signal toward the beamformee. The output signal is precoded and transmitted over the entire extended set of spectral bins, including the additional spectral bins that were not included in the received input signal. Thus, using the disclosed techniques, the beamformer is able to apply implicit feedback beamforming even when the received signal does not cover the entire spectrum of the transmitted signal.

In an example embodiment, the disclosed technique is applied in an IEEE 802.11n Access Point (AP). In this embodiment, the AP carries out implicit feedback beamforming while transmitting to a station in a High-Throughput 40 (HT-40) transmission mode. The station, however, may transmit signals in another transmission mode denoted “non-HT duplicate.” The HT-40 signal occupies several bins that are not included in the non-HT duplicate signal. By using the disclosed techniques, the AP is able to compute beam steering matrices over the entire set of HT-40 bins, based on a received non-HT duplicate signal in which some of these bins are missing.

### System Description

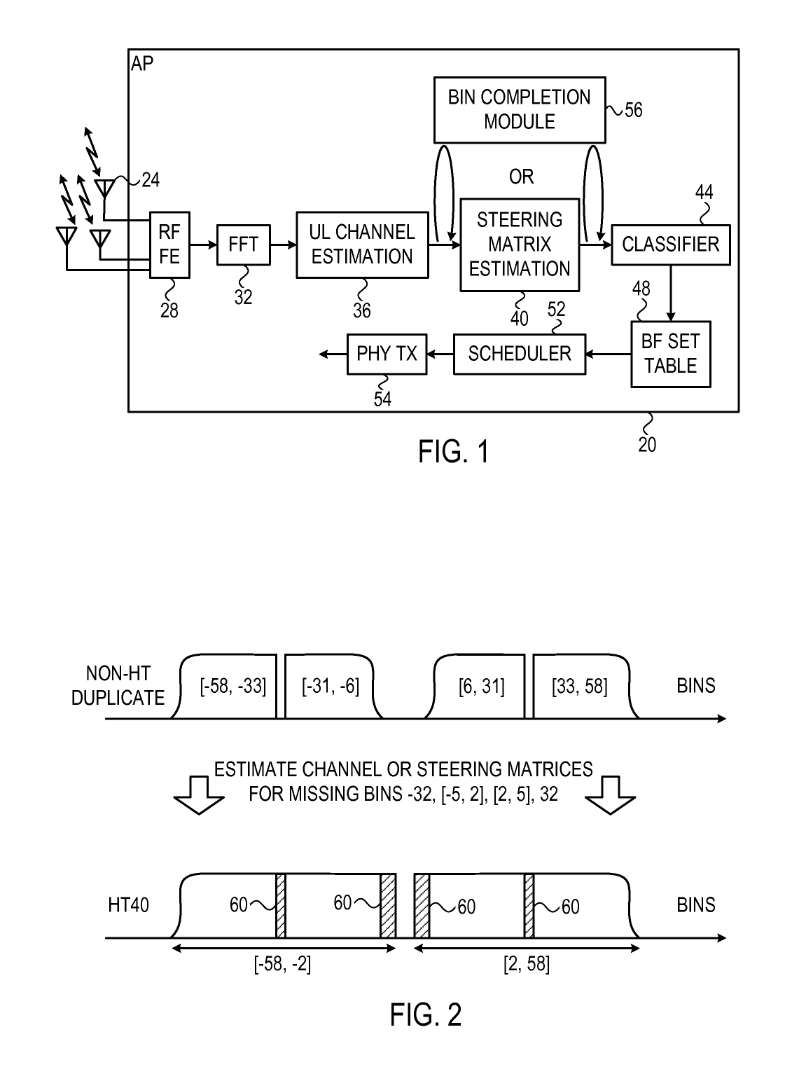

FIG. 1 is a block diagram that schematically illustrates an Access Point (AP) 20 in a Wireless Local Area Network (WLAN), in accordance with an embodiment of the present invention. In the present example, AP 20 communicates with communication stations (STA—not shown in the figure) that operate in accordance with the IEEE 802.11n standard cited above. In particular, AP 20 transmits to the stations while performing implicit feedback beamforming, using methods that are described in detail below.

AP 20 comprises an antenna array 24 that is used for transmission and reception. In the embodiment of FIG. 1, Antenna array 24 comprises three antennas. Alternatively, however, any other suitable number of antennas can be used. A Radio Frequency Front-End (RF FE) 28 receives uplink signals from the stations via the multiple antennas, down-converts the signals from RF to baseband, filters and digitizes the signals, and optionally performs functions such as amplification and gain control.

In the present example, each received signal is an Orthogonal Frequency Division Multiplexing (OFDM) signal, which is made-up of multiple modulated sub-carriers that are transmitted in respective spectral bins. An IEEE 802.11n signal, for example, comprises multiple sub-carriers that are spaced 312 KHz from one another. A Fast Fourier Transform (FFT) unit applies FFT to the received signal. For each symbol interval, the FFT unit outputs the complex values of the respective sub-carriers in that interval, for each of the antennas in array 24.

A channel estimation unit 36 estimates the response of the uplink MIMO communication channel for each spectral bin of the received uplink signal, based on the received uplink signal. In some embodiments, unit 36 estimates the channel by performing measurements on Long Training Field (LTF) symbols that are transmitted as part of the preamble of uplink messages. Unit 36 typically produces a respective channel matrix for each spectral bin (i.e., for each sub-carrier). The dimensions of each channel matrix are the number of AP antennas by the number of spatial streams that are transmitted to the AP.

A steering matrix estimation unit 40 computes a respective beam steering matrix for each spectral bin of the received uplink signal, based on the respective channel estimate produced by unit 36. The beam steering matrix of a given spectral bin gives, for each spatial stream, the complex weights that, if applied to the AP antennas at the frequency of the spectral bin, would produce a transmission beam directed to the station. The dimensions of each beam steering matrix are the number of AP antennas by the number of spatial streams that are transmitted from the AP.

The uplink signals received by AP 20 may conform to various transmission modes, which differ from one another in the sets of subcarriers they include (and thus the spectral bins they occupy). For example, a HT-40 signal occupies 114 bins whose indices are [−58 . . . 2] and [2 . . . 58], a non-HT duplicate signal occupies 104 bins whose indices are [−58 . . . −33], [−31 . . . −6],[6 . . . 31] and [33 . . . 58], and a legacy 20 MHz signal occupies 52 bins whose indices are [−26 . . . −1] and [1 . . . 26].

The set of precoding matrices used for implicit beamforming in a given transmission mode is referred to as an implicit Beamforming (BF) set, or BF set for brevity. As explained above, unit 40 computes a respective beam steering matrix for each spectral bin of the received uplink signal. In other words, unit 40 computes a BF set, which is associated with the station that transmitted the uplink signal and with the transmission mode used.

AP 20 typically holds multiple BF sets that are classified per station and per mode. In the present example, the AP comprises a BF set table 48 that holds the different BF sets. After unit 40 computes a BF set for a given station and a given transmission mode, a classifier 44 stores the BF set in table 48, classified by the station and mode.

A scheduler 52 schedules downlink frames to be transmitted by the AP. A Physical layer transmitter (PHY TX) 54 produces the appropriate downlink signals, and transmits the signals to the stations. In particular, PHY TX 54 precodes the downlink signals using the BF sets stored in table 48, as instructed by scheduler 52. In some embodiments, when preparing to transmit to a given station using a given transmission mode, scheduler 52 checks whether a BF set for that station and mode exists in table 48. If a suitable BF set exists, the scheduler instructs the PHY TX to precode the downlink signal using the beam steering matrices of that set. If no suitable BF set exists, the scheduler reverts to transmit without beamforming. (In alternative embodiments, the scheduler only schedules the frames and is not involved in checking or selecting BF sets. In such embodiments, querying of table 48 and selection of the appropriate BF set is carried out by the PHY TX. The example embodiments described herein, however, refer to these functions as being performed by the scheduler.)

In an embodiment, the availability of a suitable BF set is not checked by the scheduler. In this embodiment, the scheduler schedules a transmission regardless of whether or not a suitable BF set is available in table 48. On transmission, a dedicated module (not shown in the figure) checks whether a suitable BF set exists. In some embodiments, if no suitable BF set is found in table 48, scheduler 52 postpones the transmission until a suitable BF set is available. In some embodiments, a BF set that is aged (e.g., was created more than a predefined time period ago) is regarded as unsuitable and not used. After precoding, the precoded signal produced by PHY TX 54 is transmitted via the multiple antennas to the intended station.

As can be seen from the description up to this point, AP 20 is able to transmit to a given station over the downlink in a given transmission mode only if an uplink signal was received from this station in that mode (and therefore unit 40 was able to produce a BF set for that station and mode). If, for example, a given station does not respond on the uplink with HT-40 transmissions, the AP will not be able to transmit to it using implicit beamforming in the HT-40 mode.

As will be discussed below, the reason for this limitation is that the BF set is computed over the entire frequency spectrum used by the downlink transmission mode. If the uplink signal is missing one or more spectral bins that are part of the downlink spectrum, the AP will be unable to compute the beam steering matrices for these bins.

In order to overcome this problem, AP 20 comprises a bin completion module 56, which produces additional channel estimates or beam steering matrices for spectral bins that are missing in the received signals. In different embodiments, module 56 may operate on the outputs of channel estimation 36 or on the outputs of steering matrix estimation unit 40. The operation of module 56 is described in detail further below.

The configuration of AP 20 shown in FIG. 1 is an example configuration, which is chosen purely for the sake of conceptual clarity. In alternative embodiments, any other suitable AP configuration can also be used. In the present context, RF FE 28 and FFT unit 32 are referred to as reception circuitry that receives the uplink signals from the stations; units 36 and 40 and module 56 are referred to as processing circuitry that carry out the disclosed implicit feedback beamforming techniques; and scheduler 52 and PHY TX 54 are referred to as transmission circuitry that transmits downlink signals to the stations. In alternative embodiments, any other suitable configuration of reception, processing and transmission circuitry can be used.

Although the embodiments described herein refer mainly to WLAN AP implementation, the disclosed techniques can be implemented in any other suitable communication station or equipment.

Some elements of AP 20 may be implemented in hardware, e.g., in one or more Application-Specific Integrated Circuits (ASICs) or Field-Programmable Gate Arrays (FPGAs). Additionally or alternatively, some AP elements, e.g., module 56, can be implemented using software, or using a combination of hardware and software elements. Some of the functions of AP 20, such as the functions of module 56, may be carried out using a general-purpose processor, which are programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

### Producing Beamforming Sets Based on Partial Subset of Spectral Bins

The description that follows explains the process of computing a BF set (a set of beam steering matrices associated with a certain transmission mode) based on a signal in which one or more spectral bins are missing. In IEEE 802.11n systems, for example, a given station may respond to a HT-40 transmission with a response frame that uses the non-HT duplicate mode. In the present example, AP 20 computes a BF set for an implicit beamforming transmission in the HT-40 mode, based on a received non-HT duplicate signal.

FIG. 2 is a diagram showing spectra of signals used in an implicit feedback beamforming process, in accordance with an embodiment of the present invention. The top graph in the figure shows the spectrum occupied by the received non-HT duplicate signal—a total of 104 bins whose indices are [−58 . . . −33], [−31 . . . −6],[6 . . . 31] and [33 . . . 58]. Based on this received signal, AP 20 computes a BF set for transmitting in the HT-40 mode. The spectrum occupied by the HT-40 signal is shown at the bottom of the figure—a total of 114 bins whose indices are [−58 . . . 2] and [2 . . . 58].

By comparing the two spectra, it can be seen that the HT-40 spectrum comprises ten bins that are not included in the non-HT duplicate spectrum—the bins whose indices are −32, [−5 . . . −2], [2 . . . 5] and 32. The missing bins are shown as regions 60 at the bottom of FIG. 2. The bins in regions 60 are referred to below as “missing bins” for clarity.

In some embodiments, the processing circuitry of AP computes the beam steering matrices for the missing bins even though no received signal is available for estimating the channel at these bin frequencies. The completion operation, which is carried out by bin completion module 56, may be performed at the output of channel estimation unit 36 (i.e., between unit 36 and steering matrix computation unit 40) or at the output of unit 40 (i.e., between the beam steering estimation unit and classifier 44).

In some embodiments, module 56 operates on the outputs of channel estimation unit 36. In these embodiments, module 56 computes channel estimates for the missing bins based on channel estimates that were computed by unit 36 for the other bins. Typically although not necessarily, module 56 estimates the channel for the missing bins based on channel estimates of one or more neighboring bins (which may comprise any suitable bins in the vicinity of the missing bins, not necessarily immediate or adjacent neighbors).

In some embodiments, channel estimation unit 56 applies a smoothing operation to the channel estimates in order to improve the Signal to Noise Ratio (SNR) of the channel estimation. In such embodiments, the bin completion operation of module 56 may be performed either before or after the smoothing operation. For example, if the smoothing operation applies Least Squares (LS) or approximated LS estimation to the channel estimates on the initial bins (the non-HT duplicate bins [−58 . . . −33], [−31 . . . −6], [6 . . . 31] and [33 . . . 58]), then the LS or approximated LS estimation of the channel for the missing bins may be obtained by an appropriate linear processing after the smoothing operation. Alternatively, it may be desirable from a system implementation consideration to perform the bin completion operation before the smoothing operation, and then apply smoothing to the resulting 114-bin HT-40 channel.

After estimating the channel for the missing bins (bins −32, [−5 . . . −2], [2 . . . 5] and 32), module 56 augments these estimates to the channel estimates produced by unit 36 (channel estimates for bins [−58 . . . −33], [−31 . . . −6],[6 . . . 31] and [33 . . . 58]), to produce a complete set of channel estimates for all 114 bins of the HT-40 signal (bins [−58 . . . 2] and [2 . . . 58]).

Typically, module 56 provides the complete set of channel estimates to steering matrix estimation unit 40 while marking this set as a HT-40 set. As a result, unit 40 computes a BF set (set of beam steering matrices) for all 114 bins of the HT-40 signal, and classifier 44 stores this BF set as a HT-40 BF set in table 48. Subsequently, scheduler 52 and/or PHY TX 54 is able to perform implicit feedback beamforming toward the particular station in the HT-40 transmission mode.

Module 56 may estimate the channel for a missing bin based on the channel estimates of other bins in various ways. In some embodiments, module 56 estimates the channel for a missing bin by interpolating the values of neighboring bins. The interpolation may comprise linear interpolation or any other suitable kind of interpolation. The interpolation may consider bins on either side of the missing bin, or both. Alternatively, module 56 may extrapolate the values of neighboring bins (i.e., estimate the channel for a missing bin based on bins that are located on one side of the missing bin). As another example, module 56 may estimate the channel for a missing bin by duplicating the channel estimate of a neighboring bin. Further alternatively, module 56 may estimate the channel for a missing bin by applying any other suitable operation to the channel estimates of one or more other bins, whether neighboring the missing bin or not.

In alternative embodiments, module 56 operates on the outputs of steering matrix estimation unit 40. For example, units 36 and 40 may be embodied in a given module, and module 56 operates on the output of that module. In these embodiments, module 56 computes beam steering matrices for the missing bins based on beam steering matrices that were computed by unit 40 for the other bins. Typically although not necessarily, module 56 computes the beam steering matrices for the missing bins based on beam steering matrices of one or more neighboring bins. In various embodiments, module 56 may estimate the beam steering matrices for the missing bins by interpolating, extrapolating or duplicating beam steering matrices of one or more of the bins in the non-HT duplicate spectrum.

After estimating the beam steering matrices for the missing bins (bins −32, [−5 . . . −2], [2 . . . 5] and 32), module 56 augments these matrices to the beam steering matrices produced by unit 40 (beam steering matrices for bins [−58 . . . −33], [−31 . . . −6],[6 . . . 31] and [33 . . . 58]), to produce a complete BF set for the HT-40 signal (bins [−58 . . . 2] and [2 . . . 58]). Typically, module 56 provides the complete set of beam steering matrices to classifier 44 while marking this BF set as a HT-40 set. Classifier 44 thus stores this BF set as a HT-40 BF set in table 48, and scheduler 52 and/or PHY TX 54 is able to perform implicit feedback beamforming toward the particular station in the HT-40 transmission mode.

In the example of FIG. 2, the channel estimate (or beam steering matrix) for missing bin 32 can be duplicated from bins 31 or 33, or interpolated from the channel estimates (or beam steering matrices) of these bins, e.g., by averaging the channel estimates (or beam steering matrices) of bins 31 and 33. The interpolation or duplication may use more additional bins than the immediate neighbors. For example, the channel (or beam steering matrix) for missing bins [2 . . . 5] can be estimated by duplicating the channel response (or beam steering matrix) of bin 6, or by interpolating several bins, including bins 6 or higher, and/or −2 or lower.

In some embodiments, module 56 completes (e.g., duplicates, interpolates or extrapolates) the channel estimate (or beam steering matrix) for a missing bin using only bins having indices of the same sign as the missing bin. In these embodiments, the channel estimate (or beam steering matrix) for missing bin 2, for example, will not be affected by the channel estimates (or beam steering matrices) of bins having negative indices.

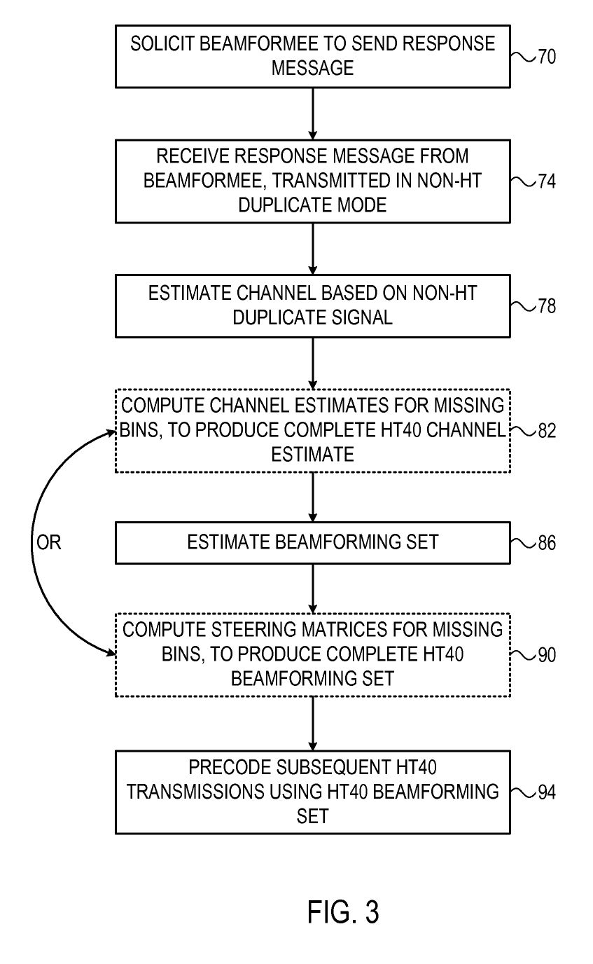

FIG. 3 is a flow chart that schematically illustrates a method for implicit feedback beamforming, in accordance with an embodiment of the present invention. In the following description, AP 20 is referred to as the beamformer, and the station with which AP 20 communicates is referred to as the beamformee.

In the present embodiment, the method begins with the beamformer soliciting the beamformee to send a response uplink message, at a solicitation step 70. For this purpose, the beamformer may use any suitable downlink frame that causes the beamformee to respond. In IEEE 802.11n systems, for example, the beamformer may transmit a RTS message that causes the beamformee to respond with a CTS message, or transmit a BAR message that causes the beamformee to respond with a BA message. In another embodiment, the beamformer may solicit the beamformee to respond using layer-3 protocol messages, such as a PING. (Note, however, that the disclosed techniques can be performed without soliciting the beamformee, i.e., by processing uplink messages that are transmitted by the beamformee to the beamformer without being solicited.)

When the beamformee responds, the beamformer receives the uplink response message, at a response reception step 74. The response is assumed to be transmitted in the non-HT duplicate mode. Channel estimation unit 36 in the beamformer estimates the channel for the 104 bins of the non-HT duplicate spectrum, at a channel estimation step 78.

In embodiments where bin completion module 56 operates on the output of unit 36, module 56 estimates the channel for the ten missing bins (the bins that are included in the HT-40 spectrum but not in the non-HT duplicate spectrum), at a channel estimate completion step 82. As explained above, the completion operation may involve, for example, interpolation, extrapolation or duplication. The resulting 114 channel estimates (104 estimates previously estimated by unit 36, plus ten estimates produced by module 56) are provided to steering matrix estimation unit 40. In embodiments where bin completion module 56 operates on the output of unit 40, step 82 is omitted.

Steering beam estimation unit 40 computes a BF set based on the channel estimates, at a BF computation step 86.

In embodiments where bin completion module 56 operates on the output of unit 40, module 56 estimates beam steering matrices for the ten missing bins (the bins that are included in the HT-40 spectrum but not in the non-HT duplicate spectrum), at a steering matrix completion step 90. The completion operation may involve, for example, interpolation, extrapolation or duplication. The resulting 114 beam steering matrices (104 matrices previously estimated by unit 40, plus ten matrices produced by module 56) are provided to classifier 44. In embodiments where bin completion module 56 operates on the output of unit 36, step 90 is omitted.

Classifier 44 stores the resulting BF set, which comprises 114 beam steering matrices for the 114 bins of the HT-40 spectrum, as a HT-40 BF set in table 48. Scheduler 52 instructs PHY TX 54 to precode subsequent HT-40 transmissions to the same beamformee using this BF set, at a precoding step 94.

### Signal Power and SNR Considerations

The non-HT duplicate signal has ten bins missing compared with the HT-40 signal. Therefore, when transmitting in the non-HT duplicate mode, each bin is transmitted at a power that is 0.4 dB higher than the bin power of used in the HT-40 mode (10 log(114/104)≅0.4 dB) in order to maintain an overall target power. In some embodiments, the AP processing circuitry ensures that the overall signal power in the non-HT duplicate mode and in the HT-40 mode is the same. After the missing bins are completed by module 56, and in case other modules are not aware of the completion operation, the resulting HT-40 signal may increase in power by 0.4 dB.

In some embodiments, the processing circuitry of AP compensates for this power increase, i.e., for the ratio between the number of spectral bins in the non-HT duplicate and in the HT-40 spectrum. In an example embodiment, the compensation is performed digitally, bin-by-bin, by scaling down the BF set values. In another embodiment, the compensation is performed by scaling down the signal after the precoding operation, for example by operating on the time domain signal before transmission. Scaling down of the time domain signal can be performed either in the digital domain or in the analog domain.

For example, in some embodiments the processing circuitry scales the analog RF signal to be transmitted from the AP, by configuring RF gain registers in the AP transmitter. Scaling the RF signal is often simpler than scaling each bin digitally. In some embodiments, the gain adjustment resolution of the AP transmitter RF circuitry is 0.5 dB. In these embodiments, the processing circuitry may scale the signal down by 0.5 dB instead of by 0.4 dB in order to reduce complexity. The residual 0.1 dB gain difference is usually tolerable.

In some embodiments, the AP processing circuitry computes an average per-stream Signal to Noise Ratio (SNR) metric for each BF set. The SNR metric, which is computed from the BF set and the channel estimate, predicts the per-stream SNR at the beamformee when the BF set is used. In some embodiments, the processing circuitry uses the SNR metric that was computed from the non-HT duplicate BF set for the completed HT-40 BF set, as well.

In other embodiments, the processing circuitry corrects the SNR metric of the non-HT duplicate BF set in a manner that takes into account the HT-40 format. For example, the processing circuitry may scale down the SNR metric of the non-HT duplicate BF set by 0.4 dB (assuming the overall signal power is unchanged, and only additional noise is added from the additional bins).

Although the embodiments described herein mainly address IEEE 802.11n systems, the methods and systems described herein can be used in various other systems and applications, such as in WLAN systems in general, for example IEEE 802.11ac systems and other variants of the IEEE 802.11 standard, as well as in other communication systems such as IEEE 802.16 compliant systems.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method for communication, comprising:
in a first communication station, receiving from a second communication station via multiple antennas an input signal having a spectrum that occupies an initial set of spectral bins;
defining an extended set of the spectral bins, which comprises the initial set and one or more additional spectral bins;
based on the received input signal, computing for the spectral bins in the extended set, including the additional spectral bins, respective beam steering matrices;
generating the output signal over the extended set of the spectral bins, including the additional spectral bins, using the respective beam steering matrices; and
transmitting the output signal from the first communication station via the multiple antennas.

2. The method according to claim 1, wherein the input signal is received over a communication channel, and wherein computing the beam steering matrices comprises:
based on the input signal, computing respective estimates of the communication channel for the spectral bins in the initial set;
based on the estimates computed for the initial set, generating respective additional estimates of the communication channel for the additional spectral bins; and
computing the beam steering matrices for the extended set based on the estimates and the additional estimates.

3. The method according to claim 2, wherein generating the additional estimates of the communication channel comprises interpolating or extrapolating or duplicating one or more of the estimates computed for the initial set.

4. The method according to claim 2, and comprising applying a smoothing operation to the estimates of the communication channel for the spectral bins in the initial set before generating the additional estimates, or jointly to the estimates and the additional estimates after generating the additional estimates.

5. The method according to claim 1, wherein the input signal is received over a communication channel, and wherein computing the beam steering matrices comprises:
based on the input signal, computing respective estimates of the communication channel for the spectral bins in the initial set;
computing the beam steering matrices for the spectral bins in the initial set based on the estimates; and
based on the beam steering matrices computed for the initial set, generating respective additional beam steering matrices for the additional spectral bins.

6. The method according to claim 5, wherein generating the additional beam steering matrices comprises interpolating or extrapolating or duplicating one or more of the beam steering matrices computed for the initial set.

7. The method according to claim 1, and comprising soliciting the second communication station to transmit the input signal by sending a message from the first communication station to the second communication station.

8. The method according to claim 1, wherein generating the output signal comprises scaling a power of the output signal to compensate for a ratio between a first number of the spectral bins in the initial set and a second number of the spectral bins in the extended set.

9. The method according to claim 1, and comprising computing a Signal to Noise Ratio (SNR) metric for the beam steering matrices of the extended set based on the SNR metric of the steering matrices of the initial set.

10. The method according to claim 9, wherein computing the SNR metric for the extended set comprises scaling the SNR metric of the initial set by a ratio between a first number of the spectral bins in the initial set and a second number of the spectral bins in the extended set.

11. The method according to claim 1, wherein the initial set of the spectral bins corresponds to a first transmission mode, and wherein the extended set of the spectral bins corresponds to a second transmission mode, different from the first transmission mode.

12. The method according to claim 11, wherein the input and output signals conform to an IEEE 802.11n standard, wherein the first transmission mode comprises a non-HT duplicate mode and wherein the second transmission mode comprises a HT-40 mode.

13. A communication apparatus, comprising:
reception circuitry, which is configured to receive from a remote communication station via multiple antennas an input signal having a spectrum that occupies an initial set of spectral bins;
processing circuitry, which is configured to define an extended set of the spectral bins comprising the initial set and one or more additional spectral bins, and to compute, based on the received input signal, for the spectral bins in the extended set including the additional spectral bins, respective beam steering matrices; and
transmission circuitry, which is configured to generate and transmit the output signal via the multiple antennas over the extended set of the spectral bins, including the additional spectral bins, using the respective beam steering matrices.

14. The apparatus according to claim 13, wherein the input signal is received over a communication channel, and wherein the processing circuitry is configured to compute the beam steering matrices by:
based on the input signal, computing respective estimates of the communication channel for the spectral bins in the initial set;
based on the estimates computed for the initial set, generating respective additional estimates of the communication channel for the additional spectral bins; and
computing the beam steering matrices for the extended set based on the estimates and the additional estimates.

15. The apparatus according to claim 14, wherein the processing circuitry is configured to generate the additional estimates of the communication channel by interpolating or extrapolating or duplicating one or more of the estimates computed for the initial set.

16. The apparatus according to claim 14, wherein the processing circuitry is configured to apply a smoothing operation to the estimates of the communication channel for the spectral bins in the initial set before generating the additional estimates, or jointly to the estimates and the additional estimates after generating the additional estimates.

17. The apparatus according to claim 13, wherein the input signal is received over a communication channel, and wherein the processing circuitry is configured to compute the beam steering matrices by:
based on the input signal, computing respective estimates of the communication channel for the spectral bins in the initial set;
computing the beam steering matrices for the spectral bins in the initial set based on the estimates; and
based on the beam steering matrices computed for the initial set, generating respective additional beam steering matrices for the additional spectral bins.

18. The apparatus according to claim 17, wherein the processing circuitry is configured to generate the additional beam steering matrices by interpolating or extrapolating or duplicating one or more of the beam steering matrices computed for the initial set.

19. The apparatus according to claim 13, wherein the processing circuitry is configured to solicit the remote communication station to transmit the input signal by sending a message to the remote communication station.

20. The apparatus according to claim 13, wherein the processing circuitry is configured to scale a power of the output signal to compensate for a ratio between a first number of the spectral bins in the initial set and a second number of the spectral bins in the extended set.

21. The apparatus according to claim 13, wherein the processing circuitry is configured to compute a Signal to Noise Ratio (SNR) metric for the beam steering matrices of the extended set based on the SNR metric of the steering matrices of the initial set.

22. The apparatus according to claim 21, wherein the processing circuitry is configured to compute the SNR metric for the extended set by scaling the SNR metric of the initial set by a ratio between a first number of the spectral bins in the initial set and a second number of the spectral bins in the extended set.

23. The apparatus according to claim 13, wherein the initial set of the spectral bins corresponds to a first transmission mode, and wherein the extended set of the spectral bins corresponds to a second transmission mode, different from the first transmission mode.

24. The apparatus according to claim 23, wherein the input and output signals conform to an IEEE 802.11n standard, wherein the first transmission mode comprises a non-HT duplicate mode and wherein the second transmission mode comprises a HT-40 mode.
